(19) United States
(12) Patent Application Publication
(10) Pub. No.: US 2026/0012328 A1
(43) Pub. Date: Jan. 8, 2026

(54) Methods and Systems for Providing Data Integrity in a Constrained Environment

(71) Applicant: Google LLC, Mountain View, CA (US)

(72) Inventors: Marshall Bennett Pierce, Huson, MT (US); Sophie Ellen Schmieg, Santa Clara, CA (US)

(21) Appl. No.: 18/881,820

(22) PCT Filed: Jul. 7, 2023
(86) PCT No.: PCT/US2023/027057

§ 371 Date: Jan. 7, 2025

Related U.S. Application Data
(60) Provisional application No. 63/367,927, filed on Jul. 8, 2022.

(51) Int. Cl. H04L 9/06

(52) U.S. Cl. CPC H04L 9/0618; H04L 2209/08; H04L 2209/80

(57) ABSTRACT

An example method includes receiving metadata associated with a plurality of computing devices. Each metadata includes an indication of a cryptographic fingerprint of secret data known to an associated computing device. The method includes receiving, over a short-range wireless communication mode, a ciphertext message broadcast by another computing device. The message is generated by an encryption algorithm that has the secure pseudo-random permutation (PRP) property and that conforms the message to a constrained packet size associated with the communication mode. A cryptographic fingerprint is derivable from the message. The method includes generating the cryptographic fingerprint. The method includes comparing the generated fingerprint with fingerprints associated with previously received metadata. The method includes, upon a determination that the generated fingerprint matches a fingerprint associated with one of the previously received metadata, establishing an integrity of the message. Establishing of the integrity is based on the PRP property of the encryption algorithm.

### CROSS-REFERENCE TO RELATED APPLICATIONS/INCORPORATION BY REFERENCE

This application claims priority to U.S. Provisional Patent Application No. 63/367,927, filed on Jul. 8, 2022, which is hereby incorporated by reference in its entirety.

### BACKGROUND

The present disclosure generally relates to message transmission over a short-range wireless communication channel. Short-range wireless communication channels have greatly improved the manner in which users may share data between connected devices.

### SUMMARY

The present disclosure generally relates to integrity validation and device authentication for an encrypted message transmitted over a short-range wireless communication channel. Example short-range wireless communication channels include Bluetooth™, and near-field communication (NFC) interfaces. As a general matter, a receiver device in a short-range wireless communication mode may be configured to scan for nearby transmitter devices. Generally, the transmitter devices broadcast messages that may be received by the receiver device, and upon authentication of the transmitter device, a communication channel can be established between the transmitter device and the receiver device. In some situations, a transmitted message may be modified by a hostile actor. As a result, the receiver device may be exposed to hostile activities.

Accordingly, there is a need for the receiver device to be able to authenticate the transmitter device, and validate the integrity of the transmitted message. However, the size of a data packet that can be transmitted over a short-range wireless communication channel may be limited, placing limits on a choice of encryption algorithms available to encrypt the transmitted message. Even in situations where the data packet size limitation may be overcome by an appropriate encryption algorithm, validation of the transmitted message may be challenging. Accordingly, there is a need for a message integrity protocol that can be effective in the context of a short-range wireless communication mode.

In a first aspect, a computer-implemented method is provided. The method includes receiving, by a first computing device, a plurality of metadata associated with a respective plurality of computing devices, wherein each metadata comprises an indication of a cryptographic fingerprint of secret data known to an associated computing device. The method also includes receiving, by the first computing device and over a short-range wireless communication mode, a ciphertext message broadcast by a second computing device, the ciphertext message having been generated at the second computing device by an encryption algorithm that conforms the ciphertext message to a constrained packet size associated with the communication mode, wherein the encryption algorithm has a secure pseudo-random permutation (PRP) property, and wherein a cryptographic fingerprint is derivable from the ciphertext message. The method further includes generating, from a decrypted version of the received ciphertext message, the cryptographic fingerprint. The method also includes comparing the generated cryptographic fingerprint with cryptographic fingerprints associated with previously received plurality of metadata. The method further includes, upon a determination that the generated cryptographic fingerprint matches a cryptographic fingerprint associated with one of the previously received plurality of metadata, establishing an integrity of the ciphertext message, wherein the establishing of the integrity is based on the PRP property of the encryption algorithm.

In a second aspect, a system is provided. The system may include one or more processors. The system may also include data storage, where the data storage has stored thereon computer-executable instructions that, when executed by the one or more processors, cause the system to carry out operations. The operations include receiving, by a first computing device, a plurality of metadata associated with a respective plurality of computing devices, wherein each metadata comprises an indication of a cryptographic fingerprint of secret data known to an associated computing device. The operations also include receiving, by the first computing device and over a short-range wireless communication mode, a ciphertext message broadcast by a second computing device, the ciphertext message having been generated at the second computing device by an encryption algorithm that conforms the ciphertext message to a constrained packet size associated with the communication mode, wherein the encryption algorithm has a secure pseudo-random permutation (PRP) property, and wherein a cryptographic fingerprint is derivable from the ciphertext message. The operations further include generating, from a decrypted version of the received ciphertext message, the cryptographic fingerprint. The operations also include comparing the generated cryptographic fingerprint with cryptographic fingerprints associated with previously received plurality of metadata. The operations further include, upon a determination that the generated cryptographic fingerprint matches a cryptographic fingerprint associated with one of the previously received plurality of metadata, establishing an integrity of the ciphertext message, wherein the establishing of the integrity is based on the PRP property of the encryption algorithm.

In a third aspect, a device is provided. The device includes one or more processors operable to perform operations. The operations include receiving, by a first computing device, a plurality of metadata associated with a respective plurality of computing devices, wherein each metadata comprises an indication of a cryptographic fingerprint of secret data known to an associated computing device. The operations also include receiving, by the first computing device and over a short-range wireless communication mode, a ciphertext message broadcast by a second computing device, the ciphertext message having been generated at the second computing device by an encryption algorithm that conforms the ciphertext message to a constrained packet size associated with the communication mode, wherein the encryption algorithm has a secure pseudo-random permutation (PRP) property, and wherein a cryptographic fingerprint is derivable from the ciphertext message. The operations further include generating, from a decrypted version of the received ciphertext message, the cryptographic fingerprint. The operations also include comparing the generated cryptographic fingerprint with cryptographic fingerprints associated with previously received plurality of metadata. The operations further include, upon a determination that the generated cryptographic fingerprint matches a cryptographic fingerprint associated with one of the previously received plurality of metadata, establishing an integrity of the ciphertext message, wherein the establishing of the integrity is based on the PRP property of the encryption algorithm.

In a fourth aspect, an article of manufacture is provided. The article of manufacture may include a non-transitory computer-readable medium having stored thereon program instructions that, upon execution by one or more processors of a computing device, cause the computing device to carry out operations. The operations include receiving, by a first computing device, a plurality of metadata associated with a respective plurality of computing devices, wherein each metadata comprises an indication of a cryptographic fingerprint of secret data known to an associated computing device. The operations also include receiving, by the first computing device and over a short-range wireless communication mode, a ciphertext message broadcast by a second computing device, the ciphertext message having been generated at the second computing device by an encryption algorithm that conforms the ciphertext message to a constrained packet size associated with the communication mode, wherein the encryption algorithm has a secure pseudo-random permutation (PRP) property, and wherein a cryptographic fingerprint is derivable from the ciphertext message. The operations further include generating, from a decrypted version of the received ciphertext message, the cryptographic fingerprint. The operations also include comparing the generated cryptographic fingerprint with cryptographic fingerprints associated with previously received plurality of metadata. The operations further include, upon a determination that the generated cryptographic fingerprint matches a cryptographic fingerprint associated with one of the previously received plurality of metadata, establishing an integrity of the ciphertext message, wherein the establishing of the integrity is based on the PRP property of the encryption algorithm.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 depicts an example network environment, in accordance with example embodiments.

FIG. 2 illustrates an example message integrity protocol, in accordance with example embodiments.

FIG. 3 illustrates an example computing device, in accordance with example embodiments.

FIG. 4 illustrates a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### Overview

A short-range wireless communication mode may be used to search for nearby devices. For example, a Bluetooth advertisement may be used to allow devices (e.g., mobile phones, wearables, speakers, and so forth) to offer functionality such as, “what devices that I own are near me,” or “what devices owned by my friends are near me,” and so forth. Such functionality is generally offered by configuring the devices to broadcast messages. For example, the Bluetooth advertisement may include data for distance estimation, various bits with data indicating whether certain features are available, enabled, and/or usable, in the short-range wireless communication mode, and a decryption key that enables a receiver device to decrypt certain additional data (e.g., device name of the broadcasting device) that the receiver device may have previously stored.

Packet sizes for data to be transmitted in a short-range wireless communication mode can be limited. For example, a Bluetooth advertisement may have a capacity of 26 bytes, with certain significant data comprising about 14 to 16 bytes. Accordingly, authenticated encryption approaches may not be viable given the constrained size requirement. For example, a hash-based message authentication code (HMAC) requires about 16 or more bytes, and a Galois/Counter Mode (GCM) tag requires about 12 or more bytes. Accordingly, when transmitting the significant data and the integrity bits, there may be no bits available to transmit additional important message data.

Accordingly, there is a need to perform integrity protection in a constrained communication environment without the typical available approaches that involve adding extra bytes, thereby rendering them impractical for use. Also, for example, there is a need to determine the identity of the sender of a message. Generally, metadata may be distributed by the broadcasting device prior to the broadcast of the message. For example, transmitter devices may transmit metadata periodically to servers, and receiver devices may download and save such data. In some examples, the transmitted metadata may include a cryptographic fingerprint of the significant data. Accordingly, the stored metadata may enable the receiver device to robustly verify that they have correctly decrypted the broadcast data including the significant data.

Generally, the data to be encrypted includes a bit less than 26 bytes, after some overhead, and is one full AES block of 16 bytes, and a partial block of approximately 8 bytes. Encryption algorithms based on block ciphers generally cannot operate on partial blocks, and require some form of padding. However, padding adds extra bits in an already constrained environment, and is therefore not a practical approach. For example, padding to a full block would yield 2×16 bytes=32 bytes, which cannot fit within a 26 byte advertisement. Also, a typical block cipher use does not provide a property that decrypting and validating the block containing the significant data would imply that other blocks are decrypted correctly and not tampered with.

As described herein, a length doubler construction on top of a tweakable block cipher (LDT) provides a secure pseudo-random permutation (PRP) property. Such an encryption algorithm operates on 1 full+1 partial block, as in the present networking environment, without changing the length. For example, the encryption algorithm can operate on a 1.x block, such as, for example, 1+ 7/16 blocks (e.g., 23 bytes) in a length-preserving manner to generate a ciphertext message of 23 bytes. Also, for example, the PRP property in conjunction with the known fingerprint of the significant data enables a determination as to whether the data has been modified (e.g., tampered with, or due to radio frequency (RF) noise). For example, when a bit is flipped in the ciphertext message, by the PRP property, the entire plaintext is rendered random with a very high probability. Accordingly, there is a very low probability that a 14 byte (112 bit) or more sized section of significant data will decrypt to a value that matches a previously stored metadata (e.g., the known cryptographic fingerprint from the metadata). In some aspects, the probability of matching is inversely proportional to the size of the significant data. Accordingly, a longer section of significant data results in a lower probability of matching, and consequently, higher integrity protection.

### Example Data Network

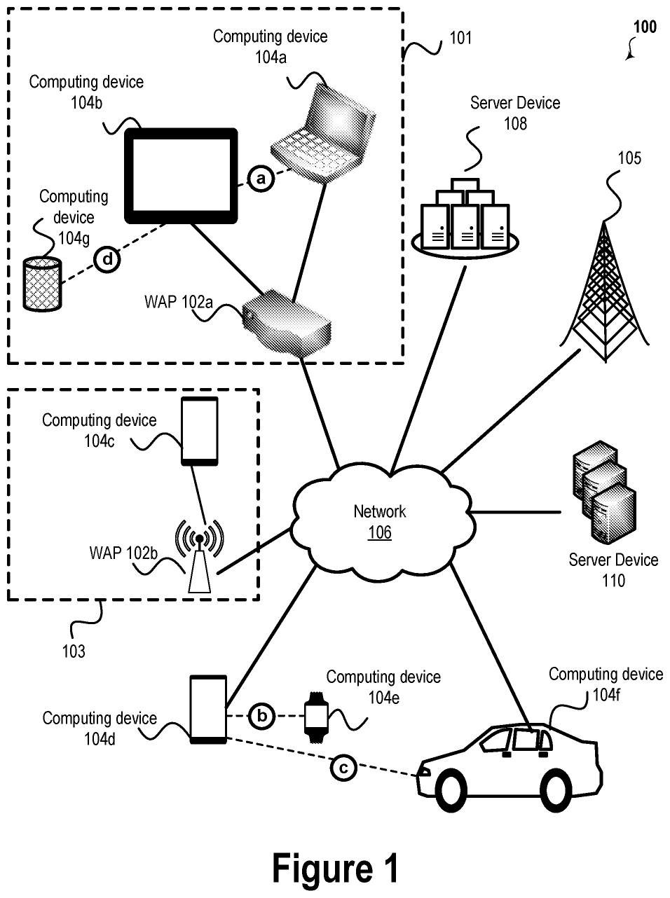

FIG. 1 depicts an example network environment 100, in accordance with example embodiments. Network environment 100 includes server devices 108, 110 that are configured to communicate, via network 106, with computing devices 104a, 104b, 104c, 104d, 104e, 104f, 102g. Network 106 may correspond to a local area network (LAN), a wide area network (WAN), a WLAN, a WWAN, a corporate intranet, the public Internet, or any other type of network configured to provide a communications path between networked computing devices. Network 106 may also correspond to a combination of one or more LANs, WANs, corporate intranets, and/or the public Internet. Network 106 can include, but is not limited to, any one or more of the following network topologies, including a bus network, a star network, a ring network, a mesh network, a star-bus network, tree or hierarchical network, and the like.

Although FIG. 1 only shows seven computing devices (e.g., programmable devices), a distributed application architecture may serve tens, hundreds, or thousands of programmable devices. Moreover, computing devices 104a-104g (or any additional programmable devices) may be any sort of computing device, such as a mobile computing device, desktop computer, wearable computing device, head-mountable device (HMD), network terminal, a mobile computing device, a gaming console, an intelligent assistant, a network appliance, a camera, a cellular phone, a smart phone, a speaker, and so on.

In some examples, such as illustrated by computing devices 104d, 104g, computing devices can be directly connected to network 106. In other examples, such as illustrated by computing devices 104a, 104b, 104c, 104e, 104g, computing devices can be indirectly connected to network 106 via an associated computing device. For example, computing devices 104a, 104b, and 104g can be indirectly connected to network 106 via a wireless access point (WAP), such as WAP 102a. As another example, computing device 104c can be indirectly connected to network 106 via an access point such as WAP 102b. Also, for example, computing device 104e can be indirectly connected to network 106 via computing device 104d. In this example, computing device 104d can act as an associated computing device to pass electronic communications between computing device 104e and network 106. In other examples, such as illustrated by computing device 104f, a computing device can be part of and/or inside a vehicle, such as a car, a truck, a bus, a boat or ship, an airplane, etc. In other examples not shown in FIG. 1, a computing device can be both directly and indirectly connected to network 106.

In some examples, one or more computing devices may communicate with each other in a short-range wireless communication mode. For example, computing device 104a may communicate with computing device 104b in a short-range wireless communication mode “a,” and computing device 104b may communicate with computing device 104g (e.g., a speaker) in a short-range wireless communication mode “d.” As another example, computing device 104d may communicate with computing device 104e in a short-range wireless communication mode “b,” and may communicate with computing device 104f in a short-range wireless communication mode “c.” For example, computing device 104d may be a user's mobile device, and the mobile device may be communicating with a wearable device computing device 104e. Also, for example, the user may be in a vehicle equipped with computing device 104f, and the mobile device may be communicating with the vehicle's computing system.

In some embodiments, the short-range wireless communication mode may be a Bluetooth™ communication mode. In some embodiments, the short-range wireless communication mode may be a near-field communication (NFC) mode.

In some examples, network environment 100 includes wireless local area networks (WLAN) 101 and 103 and service tower 105. WLAN 101 can include wireless access point (WAP) 102a and computing devices 104a, 104b, and WLAN 103 can include WAP 102b and computing device 104c. Computing devices 104a, 104b, and 104c can allow a user to access a wireless local area network, such as WLAN 101 or 103, by authenticating credentials of the user with an authentication service, such as provided by a wireless access point, such as WAP 102a or 102b.

Server devices 108, 110 can be configured to perform one or more services, as requested by computing devices 104a-104g. For example, server device 108 and/or 110 can provide content to computing devices 104a-104g. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 108 and/or 110 can provide computing devices 104a-104g with access to software for database, search, computation, graphical, audio, video, World Wide Web/Internet utilization, and/or other functions. Many other examples of server devices are possible as well.

For example, server device 108 can include one or more computing devices and one or more computer-readable storage devices (e.g., data stores). Server device 108 may be a system or device having a processor, a memory, and communications capability for providing content and/or services to client devices. In some example aspects, server device 108 can be a single computing device, for example, a computer server. In other embodiments, server device 108 can represent more than one computing device working together to perform the actions of a server computer (e.g., cloud computing). Further, server device 108 can represent various forms of servers including, but not limited to an application server, a proxy server, a network server, an authentication server, an electronic messaging server, a content server, etc., accessible to the computing devices 104a-104g. In some aspects, server device 108 may be an authentication server that provides user authentication services for wireless local area network access. For example, a plurality of computing devices may send metadata (e.g., device identifier information including a cryptographic fingerprint) to server device 108. Such metadata may be sent to server device 108 periodically. Also, for example, one or more computing devices may receive the metadata associated with the plurality of computing devices from server device 108.

For example, computing devices 104a, 104b, and 104g may transmit metadata to server device 108 at various times. In turn, computing device 104b may receive transmitted metadata associated with computing devices 104a, 104g from server device 108 over a period of time, and may store the metadata. Also, for example, computing devices 104a, 104g may broadcast encrypted messages (e.g., ciphertext message) that includes data with a respective cryptographic fingerprint. For example, computing device 104b may desire to exchange data with one or more of computing devices 104a, 104g (e.g., by establishing a short-range wireless communication interface). Accordingly, computing device 104b may want to authenticate one or more of computing devices 104a, 104g as a known device. Also, for example, computing device 104b may want to validate that the broadcasted message has not been tampered with (e.g., during transit). As described herein, such operations may be performed based on a comparison of the cryptographic fingerprint included in the previously received metadata and the cryptographic fingerprint of certain data in the plaintext of received encrypted message. Generally, a portion of the decrypted message is enough to perform such operations. This can result in savings in compute resources. After computing device 104b determines that, for example, computing device 104a is a known (e.g., trusted) device, and that a ciphertext message broadcast by computing device 104a has not been tampered with, computing device 104b may establish a connection with computing device 104a and/or exchange data.

Server device 110 may be a system or device having a processor, a memory, and communications capability for providing content and/or services to client devices. In some example aspects, server device 110 can be a single computing device, for example, a computer server. In other embodiments, server device 110 can represent more than one computing device working together to perform the actions of a server computer (e.g., cloud computing). Server device 108 and/or 110 may be implemented as a single server or across multiple servers. Server device 110 may perform various functionalities and/or storage capabilities described herein either alone or in combination with server device 108. Each of server devices 108 and/or 110 may host various services, including cloud-based services. A cloud-based service may require authentication of a user account for access via a cloud-based application, such as a web-based personal portal or a web-based email application.

For example, a user may interact with content and/or services hosted by server device 108, through a client application installed at computing device 104a, such as a web browser application. Communication between computing device 104a and server device 108 may be facilitated through WLAN 101 and network 106 via WAP 102a.

Computing devices 104a-104g may communicate wirelessly with service tower 105 through a local communication interface, which may include digital signal processing circuitry where necessary. The communication interface may provide for communications under various modes or protocols, for example, Long Term Evolution (LTE) voice and data, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA3000, or General Packet Radio System (GPRS), among others.

Communication between clients (e.g., wireless client devices 112, 114, 122, and/or 124) and servers (e.g., server 130 and/or servers 140) can occur via a virtual private network (VPN), Secure Shell (SSH) tunnel, Transport Layer Security (TLS) tunnel, Extensible Authentication Protocol (EAP)-TLS based tunnel, tunnel on top of GAS/ANQR or other secure network connection.

WLANs 101 or 103 can include, but are not limited to, a computer network that covers a limited geographic area (e.g., an airport, a cafe, a train station, an office, a school, a university, and so forth). Computing devices 104a-104g may be associated with WAP 102a or WAP 102b using wireless fidelity (Wi-Fi) standards (e.g., IEEE 802.11). In some examples, Wi-Fi access standards may include Passpoint or Enterprise networks. Protected access may be provided over these networks using various security protocols, such as, WPA3™, WPA3-Personal, WPA3-Enterprise, and so forth.

As a general matter, a Wi-Fi standard can include multiple frequency bands (e.g., 2.4 Gigahertz (GHz), 5 GHz, etc.). For example, a 2.4 GHz band can include 11 distinct channels associated with 11 carrier frequencies. A wireless access point, such as WAP 102a or WAP 102b can scan these frequencies to detect a presence of a computing device (e.g., computing devices 104a-104g) by determining whether a computing device is transmitting on a particular frequency. In some examples, WAP 102a or WAP 102b may transmit a probe request on a particular frequency to seek a response from a computing device.

For each computing device detected by WAP 102a or WAP 102b, the wireless access point may attempt to obtain an associated identifier, such as a service set identifier (SSID), basic service set identifier (BSSID), and/or media access control (MAC) address. Other identifiers, such as serial numbers or Internet Protocol (IP) addresses may be used instead of, or as well as, these identifiers.

### Example Message Integrity and/or Device Identity Protocols

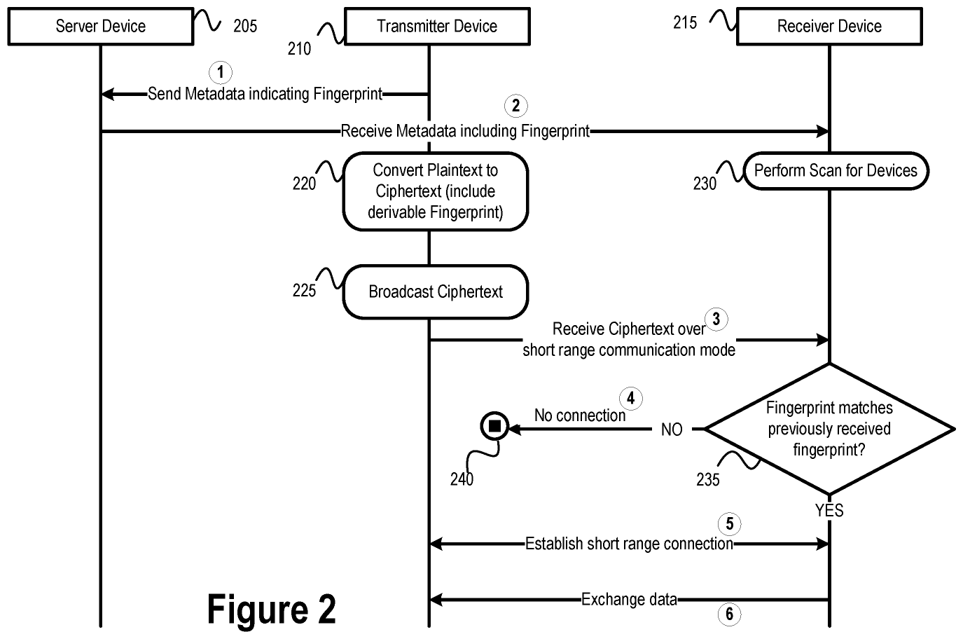

FIG. 2 illustrates an example message integrity protocol, in accordance with example embodiments. Server device 205 may share one or more aspects in common with server device 108 of FIG. 1. In some embodiments, a plurality of computing devices may send metadata (e.g., device identifier information including a cryptographic fingerprint) to server device 205. Metadata may include a device name, a device type (e.g., phone, car, tablet, wearable, and so forth), a profile image for a user, a thumbnail image (e.g., an image of the car, or a device, or a user of the device), and so forth. Such metadata may be sent to server device 205 periodically. For example, at 1, transmitter device 210 may send metadata to server device 205. In some embodiments, the metadata may be in encrypted form. For example, AES-GCM with a secret key may be used for the metadata.

One or more computing devices may receive the metadata from server device 205. In some embodiments, at 2, receiver device 215 may receive a plurality of metadata associated with a respective plurality of computing devices. Each metadata may include an indication of a cryptographic fingerprint of secret data known to an associated computing device. For example, at 2, receiver device 215 may receive the metadata associated with transmitter device 210 (e.g., transmitted at 1) from server device 205. Transmitter device 210 may possess secret data “squirrel” with a corresponding cryptographic fingerprint “123.” Receiver device may store an association, “transmitter device 210→123”. As another example, another computing device “B” may possess secret data “chicken” with a corresponding cryptographic fingerprint “456.” Receiver device may store an association, “B→456”. In general, receiver device 215 may receive metadata associated with a plurality of devices, and may save the metadata in memory. Also, for example, receiver device 215 may update application programs such as a contacts list. For example, receiver device 215 may update a photograph associated with an individual or organization on a contact list stored by receiver device 215. Also, for example, receiver device 215 may store recent versions of cryptographic fingerprints associated with the plurality of devices.

In some embodiments, at block 220, transmitter device 210 may encrypt a message to be broadcast by converting a plaintext message into a ciphertext message. For example, the plaintext message may be encrypted at transmitter device 210 by an encryption algorithm that conforms the ciphertext message to a constrained packet size associated with the short-range wireless communication mode. Also, for example, transmitter device 210 may include data related to portions of the metadata previously transmitted to server device 205 (e.g., at 1). For example, transmitter device 210 may include the data matching a cryptographic fingerprint that may enable receiver device 215 to identify transmitter device 210, and/or determine an integrity of the ciphertext message.

The term “constrained packet size” generally refers to a packet size limitation for data packets transmitted by the short-range wireless communication mode. For example, transmission of data in a Bluetooth LE (BLE) 4.2 advertisement may be limited by a small packet size of 31 bytes, which may be reduced to around 27 by various metadata bytes. However, in exchanging data packets across devices, it is desirable to maintain confidentiality (e.g., only intended receivers may access the plaintext of the message), and integrity (e.g., intended receivers can verify that the message has not been tampered with in transit).

A constrained packet size generally means that common cryptographic techniques for integrity protection are either onerous or practically impossible to implement for a given short-range wireless communication mode. For instance, an HMAC would typically take up 32 bytes. Maintaining a suitable size of the HMAC does not leave sufficient bytes to store a useful amount of data in the advertisement. In some aspects, a compact cryptographic fingerprint (e.g., Ed25519) may be 64 bytes and it may not be possible to truncate it, and is unlikely to be of practical use. Accordingly, the encryption algorithm that encrypts the plaintext message into a ciphertext message has to conform to such a constrained packet size, while providing useful data integrity protection.

Generally, confidentiality may be achieved by an encryption algorithm such as, for example, an advanced encryption standard counter mode (AES-CTR). Typical block cipher modes like AES-cipher block chaining (AES-CBC) cannot be used as they require padding. Although a plaintext can be padded to a next higher multiple of the 16 byte block cipher size of the AES scheme, padding would inflate the plaintext to 16×2=32 bytes. However, 32 bytes cannot be fitted into a constrained data packet size of 26 bytes. AES-CTR transforms AES into a stream cipher and does not require padding. However, AES-CTR is not appropriate for integrity checks. For example, if a message encrypted with AES-CTR were to be tampered with, the tampered bits would appear upon decryption, but the cryptographic fingerprint of data outside of the tampered bits may not be impacted. Accordingly, an inspection of the cryptographic fingerprint may not be indicative as to whether a message in the broadcast has been tampered with.

A secure pseudo-random permutation (PRP) property generally means that any change to a plaintext (resp., ciphertext) message during encryption (resp., decryption), and/or transmission, may result in a 50-50 chance of flipping each individual bit in the output. In other words, when an entire plaintext (resp., ciphertext) message is encrypted (resp., decrypted) “all at once,” as opposed to one block or bit at a time, any changes to a bit can propagate to the rest of the message. The risk of not detecting that the ciphertext message may have been modified by a hostile actor is similar to odds that all 14*8=112 bits in a 14-byte piece of data with the known fingerprint would remain the same. The probability of such occurrence is 1:(2¹¹²−1), which is approximately 0.2*10⁻³³. Accordingly, the PRP property in conjunction with the known fingerprint provides probabilistically reasonable integrity protection, with little to no additional space overhead.

In some embodiments, the encryption algorithm may be a variable-input-length (VIL) encryption algorithm. In some embodiments, the encryption algorithm may be a length doubling algorithm. The term “length doubler,” as used herein, generally refers to a deterministic length-preserving bijection, Ξ: K×M→M, where M={0, 1}^{[n . . . 2n-1]}, and where K is a key from {0, 1}^{k} and n is a block size of an underlying primitive.

In some embodiments, a length doubler construction built on tweakable block ciphers (e.g., LDT) may be used as the encryption algorithm. An example of a tweakable block cipher is xor-encrypt-xor (XEX). In some embodiments, a length-doubler with tweakable block ciphers may be generated from a tweakable block cipher with a mixing function.

For example, a plaintext message M may include a whole message, M₁ of size n, and a fractional-block message M₂ of size s. A first tweakable block cipher, \tilde{E}_{K}_{₁}, with first tweak, T₁, may be applied to M₁, to transform it to a message comprising a first part Z and a second part M₃. Messages M₂ and M₃ may be mixed together using a mixing function to generate respective ciphertext messages C₂ and C₃. The mixing function may be, for example, mix: S²→S² for S={0, 1}^{[0 . . . 2n-1]}.

A second tweakable block cipher, \tilde{E}_{K}_{₂}, with second tweak, T₂, may be applied to the first part Z and ciphertext message C₃, to generate ciphertext message C₁. As a result, the plaintext M comprising M₁ and M₂ may be encrypted as ciphertext message C comprising C₁ and C₂.

It is known that a length-doubler with tweakable block ciphers has the PRP property. Generally, a block has size 16 bytes. In some embodiments, the constrained packet size associated with the communication mode may be 31 bytes, and a size of the ciphertext message may be less than 32 bytes. Accordingly, as described previously, a length-doubler with tweakable block ciphers is appropriate for message encryption for messages to be transmitted via a short-range wireless communication mode.

In some embodiments, a size of the ciphertext message may be greater than 32 bytes. In some embodiments, the encryption algorithm may be a wide block cipher algorithm. In some embodiments, the wide block cipher algorithm may be utilized for a ciphertext message of size between 16 and 32 bytes. Some examples of wide block cipher algorithms may involve, for example, a Protected-IV construction (PIV), a tweakable cipher (e.g., TCT₁, TCT₂), and so forth.

At block 225, transmitter device 210 may broadcast the ciphertext message over a short-range wireless communication channel. For example, transmitter device 210 may broadcast the ciphertext message over Bluetooth. Generally, the broadcast ciphertext message is configured to include cryptographic information associated with the broadcasting computing device, such as, for example, transmitter device 210.

At block 230, receiver device 230 may scan a local area network for devices. For example, receiver device 230 may scan short-range wireless communication channels (e.g., an NFC channel, a Bluetooth channel, and so forth), to detect nearby devices (e.g., devices within a threshold distance). During such scanning, at 3, receiver device 230 may receive the ciphertext message broadcast by transmitter device 210 over the short-range wireless communication channel. Generally, devices may manage visibility profiles that may restrict a type and/or an amount of information that may be visible publicly.

Some embodiments involve decrypting the received ciphertext message. Generally, the decryption algorithm may mirror the encryption algorithm used to generate the ciphertext message. In some embodiments, metadata previously received by receiver device 230 may include a key and a fingerprint, and receiver device 230 may attempt to use the key and fingerprint in tandem to decrypt the ciphertext message.

Some embodiments involve generating, from the decrypted version of the received ciphertext message, the cryptographic fingerprint. For example, per-device metadata previously received may include some encrypted data. However, the fingerprint to be searched for may be included in the metadata as plaintext. Accordingly, receiver device 215 may receive broadcast from an unknown device. For each metadata received, receiver device 215 may use the decryption key in the metadata to decrypt the ciphertext message. Receiver device 215 may then determine the fingerprint of a portion of the plaintext.

Some embodiments involve comparing the generated cryptographic fingerprint with cryptographic fingerprints associated with previously received plurality of metadata. If the fingerprint matches the fingerprint in the metadata downloaded from server device 205, then transmitter device 210 may be identified as a known device. If there is no match, the comparison may be performed with another metadata corresponding to another device. For example, receiver device 215 may have stored a device and associated fingerprint such as “A→123” and “B→456”. Upon decrypting the ciphertext message (e.g., advertisement) from transmitter device 210, receiver device 215 may determine that the plaintext includes the fingerprint “123.” In some embodiments, every metadata from every device may be compared until a match is found, or no match is found. However, algorithms may be configured to compare a subset of the metadata to reduce computational time and increase efficiency.

In some embodiments, upon a determination that the generated cryptographic fingerprint matches a cryptographic fingerprint associated with one of the previously received plurality of metadata, an integrity of the ciphertext message may be established, wherein the establishing of the integrity is based on the PRP property of the encryption algorithm. For example, at block 235, receiver device 230 may compare a portion of the decrypted ciphertext message (e.g., the cryptographic fingerprint of the portion) received at 3, with a plurality of previously stored cryptographic fingerprint, such as the cryptographic fingerprints received at 2. As described previously, for a ciphertext message that is encrypted with an encryption algorithm that has the PRP property, any changes to a bit can propagate to the rest of the message with a very high likelihood. Accordingly, there is a high likelihood that changes to a portion of a message can propagate to the cryptographic fingerprints. Accordingly, a comparison of the generated cryptographic fingerprint to the cryptographic fingerprints associated with one of the previously received plurality of metadata can enable a determination of an integrity of the received ciphertext message.

Continuing with the example, receiver device 215 may have stored a device and associated fingerprint such as “A→123” and “B→456”. Upon decrypting the ciphertext message (e.g., advertisement) from transmitter device 210, receiver device 215 may determine that the plaintext includes the fingerprint “123.” Accordingly, upon a comparison with the cryptographic fingerprints associated with one of the previously received plurality of metadata, receiver device 215 may identify transmitter device 210 as device “A”. However, upon decrypting the ciphertext message (e.g., advertisement) from transmitter device 210, receiver device 215 may determine that the plaintext includes the fingerprint “789.” Accordingly, upon a comparison with the stored associations (based on previously received metadata), receiver device 215 may determine that the fingerprint “789” does not match the stored fingerprints “123,” and “456,” associated with known devices “A’ and “B”. Accordingly, receiver device 215 may determine that transmitter device 210 is an unknown device, or that the ciphertext message has been tampered with. Although devices “A’ and “B” are used for illustrative purposes, in general, there may be a plurality of metadata from a plurality of computing devices.

Upon a determination that the cryptographic fingerprint derived from the ciphertext message does not match the cryptographic fingerprints associated with one of the previously received plurality of metadata, receiver device 215 may terminate processing of the ciphertext message at 240. For example, a short-range wireless communication mode may not be established with transmitter device 210. Upon a determination that the cryptographic fingerprint received with the ciphertext message matches at least one of the cryptographic fingerprints associated with one of the previously received plurality of metadata, in some embodiments, receiver device 215 may establish a short-range wireless communication channel with transmitter device 210 at 5. In some embodiments, receiver device 215 may not establish a short-range wireless communication channel with transmitter device 210. In some embodiments, at 8, receiver device 215 and transmitter device 210 may share data over the short-range wireless communication channel.

### Example Computing Devices

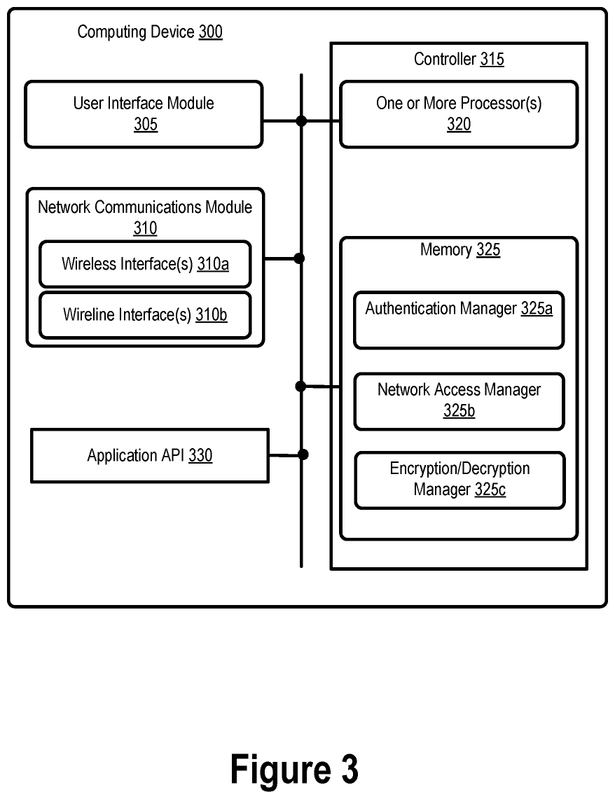

FIG. 3 illustrates an example computing device 300, in accordance with example embodiments. Computing device 300 includes user interface module 305, network communications module 310, and controller 315. Controller 315 may include one or more processor(s) 320, and memory 325. In some embodiments, network communications module 310 may include wireless interface(s) 310a, and wireline interface(s) 310b. In some examples, computing device 300 may take the form of a desktop device, a server device, or a mobile device. In some embodiments, computing device 300 may share one or aspects with computing devices 104a-104g of FIG. 1, and/or with receiver device 215 of FIG. 2. Computing device 300 may operate on multiple platforms and form factors, such as, for example, an Android operating system with form factors for a phone, a tablet, a wearable device, an automobile, a television. Also, for example, computing device 300 may be a smart speaker and/or display with a form factor such as Cast OS, Fuschia, and so forth. Also, for example, operating systems may include WINDOWS® operating system (Windows OS), CHROME® operating system (CrOS), WearOS, APPLE® operating system (iOS), RTOS for FITBIT®, and so forth.

User interface module 305 may be configured to provide output signals to a user and receive input signal from a user by way of one or more screens (including touch screens), cathode ray tubes (CRTs), liquid crystal displays (LCDs), light emitting diodes (LEDs), organic LEDs (OLEDs), displays using digital light processing (DLP) technology, and/or other similar technologies. User interface module 305 may also be configured to generate audible outputs, such as with a speaker, speaker jack, audio output port, audio output device, earphones, and/or other similar devices. User interface module 305 may be further configured with one or more haptic components that can generate haptic outputs, such as vibrations and/or other outputs detectable by touch and/or physical contact with computing device 300.

Network communications module 310 can include one or more wireless interfaces and/or wireline interfaces that are configurable to communicate via a network. Wireless interfaces 310a can include one or more wireless transmitters, receivers, and/or transceivers, such as a short-range wireless transceiver (e.g., a Bluetooth™ transceiver, an NFC transceiver), a Zigbee® transceiver, a Wi-Fi™ transceiver, a WiMAX™ transceiver, and/or other similar types of wireless transceivers configurable to communicate via a wireless network. Wireline interfaces 310b can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some embodiments, network communications module 310 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, a protocol that has the PRP property and can encode fractional-block message data in a length-preserving manner. For example, the algorithm may be a length doubler construction (LDT) on top of a tweakable block cipher. Additional, and/or alternative algorithms may be used, such as a wide block cipher algorithm, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

Controller 315 may include one or more processor(s) 320 and memory 325. Processor(s) 320 can include one or more general purpose processors and/or one or more special purpose processors (e.g., display driver integrated circuit (DDIC), digital signal processors (DSPs), tensor processing units (TPUs), graphics processing units (GPUs), application specific integrated circuits (ASICs), etc.). Processor(s) 320 may be configured to execute computer-readable instructions that are contained in memory 325 and/or other instructions as described herein.

Memory 325 may include one or more non-transitory computer-readable storage media that can be read and/or accessed by processor(s) 320. The one or more non-transitory computer-readable storage media can include volatile and/or non-volatile storage components, such as optical, magnetic, organic, or other memory or disc storage, which can be integrated in whole or in part with at least one of processor(s) 320. In some examples, memory 325 can be implemented using a single physical device (e.g., one optical, magnetic, organic or other memory or disc storage unit), while in other examples, memory 325 can be implemented using two or more physical devices.

In example embodiments, processor(s) 320 are configured to execute instructions stored in memory 325 to carry out operations.

The operations include receiving, by a first computing device, a plurality of metadata associated with a respective plurality of computing devices, wherein each metadata comprises an indication of a cryptographic fingerprint of secret data known to an associated computing device.

The operations also include receiving, by the first computing device and over a short-range wireless communication mode, a ciphertext message broadcast by a second computing device, the ciphertext message having been generated at the second computing device by an encryption algorithm that conforms the ciphertext message to a constrained packet size associated with the communication mode, wherein the encryption algorithm has a secure pseudo-random permutation (PRP) property, and wherein a cryptographic fingerprint is derivable from the ciphertext message.

The operations further include generating, from a decrypted version of the received ciphertext message, the cryptographic fingerprint.

The operations also include comparing the generated cryptographic fingerprint with cryptographic fingerprints associated with previously received plurality of metadata.

The operations further include, upon a determination that the generated cryptographic fingerprint matches a cryptographic fingerprint associated with one of the previously received plurality of metadata, establishing an integrity of the ciphertext message, wherein the establishing of the integrity is based on the PRP property of the encryption algorithm.

In some embodiments, the operations may be performed by one or more managers that may be configured to perform the operations. The one or more managers may include, authentication manager 325a, network access manager 325b, and encryption/decryption manager 325c.

Authentication manager 325a may be configured to determine an integrity of a received message by comparing a cryptographic fingerprint derived from the message to a previously received cryptographic fingerprint associated with one of the previously received plurality of metadata. As described herein, the determination of the integrity is based on the pseudo-random permutation property of the encryption algorithm. In some embodiments, authentication manager 325a may be configured to, upon a determination that the cryptographic fingerprint associated with the transmitter device matches a previously received cryptographic fingerprint, authenticate the integrity of a received ciphertext message. As another example, upon the determination that the cryptographic fingerprint derived from the message matches a cryptographic fingerprint associated with one of the previously received plurality of metadata, authentication manager 325a may be configured to identify the transmitter device as a previously identified computing device.

In some embodiments, computing device 300 may receive, over the short-range wireless communication mode, a second ciphertext message broadcast by another transmitter device. The second message may generate a second cryptographic fingerprint. Authentication manager 325a may be configured to determine that the second cryptographic fingerprint associated with the second message does not match a cryptographic fingerprint of the previously received plurality of cryptographic fingerprints. Accordingly, authentication manager 325a may be configured with logic that infers, based on the pseudo-random permutation property of the encryption algorithm, that a modification of a portion of the second ciphertext message has caused a modification of the second cryptographic fingerprint. Accordingly, authentication manager 325a may be configured to determine that an integrity of the second ciphertext message has been compromised. Also, for example, authentication manager 325a may be configured to tag the other transmitter device as an unidentified device.

Network access manager 325b may be configured to identify and/or select one or more short range wireless communication networks that a user of computing device 300 is authorized to access. In some embodiments, network access manager 325b may be configured to receive a list of one or more devices that the user is authorized to access over a short range wireless communication network.

Network access manager 325b may be configured to manage wireless connections between computing device 300 and a transmitter device or a receiver device. Network access manager 325b may be configured to discover a device and determine that the device is within a threshold distance of the first computing device. For example, the threshold distance may indicate whether data may be securely exchanged between computing device 300 and the discovered device. In some embodiments, network access manager 325b may be configured to establish a short-range wireless communication network between computing device 300 and the discovered device. For example, network access manager 325b may be configured to support bi-directional short-range wireless connection between a receiver device and a transmitter device, and/or support auto-connection to a trusted device.

Encryption/decryption manager 325c may be configured to perform encryption and/or decryption of transmissions. For example, when computing device 300 acts as a transmitter device, encryption/decryption manager 325c may be configured to encrypt a metadata to be sent to a server. Also, for example, encryption/decryption manager 325c may be configured to encrypt a broadcast message to be broadcast over a short range wireless communication network. For example, encryption/decryption manager 325c may be configured to apply an encryption algorithm such as, an algorithm that has the PRP property and can encode fractional-block message data in a length-preserving manner. For example, the algorithm may be a length doubler construction (LDT), such as, for example, built on top of a tweakable block cipher. Also, for example, encryption/decryption manager 325c may be configured to apply a wide block cipher algorithm. Similarly, when computing device 300 acts as a receiver device, encryption/decryption manager 325c may be configured to decrypt the metadata received from the server, and/or decrypt the message received from a transmitter device. The encryption algorithm may be a variable-input-length (VIL) block encryption algorithm for fractional-block message data.

Application API 330 may be configured to be an interface (e.g., by an application programming interface (API)) to communicate with one or more application programs on computing device 300. API 330 may communicate results of a data integrity process to an application program. For example, when a transmitter device is identified as a known device, and integrity of the data transmitted by the transmitter device is authenticated, API 330 may be configured to provide the authenticating of the integrity of the received ciphertext message to an application installed on computing device 300. For example, API 330 may be configured to send instructions to an application program that it is safe to process the data transmitted by the transmitter device. In some embodiments, API 330 may be configured to perform, based on the determination that the transmitter device is within a threshold distance, a proximate interaction with the transmitter device. The term “proximate interaction” may generally refer to an operation where two devices within a threshold distance are capable of establishing a connection for private communication, including for exchanging, transmitting, and/or receiving data.

The term “application program” as used herein, can be any computer program that is configured to share data with another computing device (e.g., over a short range communication mode). Example application programs can include a media playback application (e.g., play media content on a mobile device and send it to a speaker, share media content across devices), a search application (e.g., share search results between two devices), an email application (e.g., begin a draft of an email at one device and share it with another device for completion, transmission, printing, and so forth), a web browsing application (e.g., share web data between two devices, such as synchronizing bookmarks, history, and so forth), a mapping application (e.g., search for directions on a mobile device and transmit the directions to a computing device associated with a vehicular navigation system), a weather application (e.g., share weather related information across devices), a phone application (e.g., share contacts across devices), a video communication application (e.g., share contacts, meeting information, recordings, and so forth across devices), a camera application (e.g., share images and videos across devices), an application associated with a service provider (e.g., financial, insurance, etc.), an application associated with a digital assistant (e.g., a home assistant), or any other application program configured to receive user input such as speech audio input, digital text input, alpha-numeric input, character input, and/or digital image input.

In some embodiments, a user interaction with computing device 300 may initiate a broadcast by computing device 300. The term “user interaction” can broadly refer to any activity, active and/or passive, performed by a user with computing device 300, or an application program on computing device 300. For example, an interaction can involve viewing content, listening to content, inputting, editing, and/or modifying content (e.g., via a keyboard, a mouse, a tap, and so forth), a sensory interaction (e.g., haptic, visual, auditory, tactile, and so forth), a scrolling interaction, a voice interaction, a user selection, and so forth.

In some embodiments, the user interaction may be an interaction with a digital assistant (e.g., an intelligent digital assistant). For example, the user may send voice commands, such as, for example, “turn on the lights in the patio,” “play music on the den speaker,” “unlock the front door,” and so forth. In some embodiments, the user interaction may be an interaction with a search assistant. For example, the user may input text into a search field of a web browser. As another example, the user may use voice instructions to enter a search term, such as, for example, “find the nearest gas station.”

In some embodiments, the user interaction may be an interaction with a map application. For example, the user may input a street address as a text input in an address entry field for a mapping application. Also, for example, the user may use voice instructions to input a destination for a navigation application. For example, the user may say, “take me home,” or “find me a route with no tolls,” “is there public transport to the Globe Theater,” and so forth. Generally, when the user interaction results in data sharing across devices, it may be desirable for a receiving device to identify a transmitting device as a trusted device, and/or validate an integrity of the data transmitted by the transmitting device.

### Example Methods

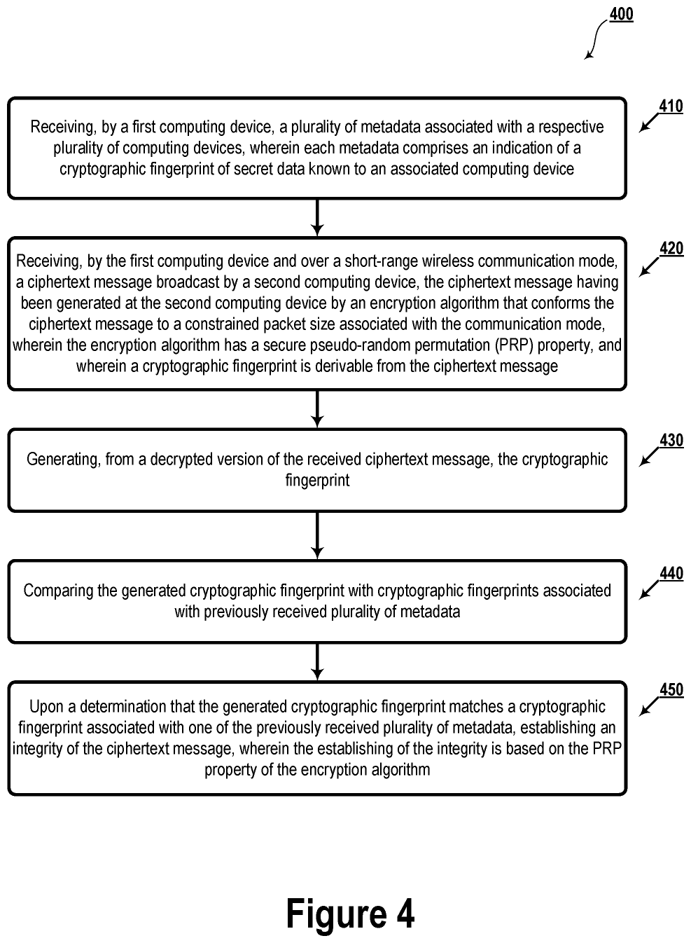

FIG. 4 illustrates a method 400, in accordance with example embodiments. Method 400 may include various blocks or steps. The blocks or steps may be carried out individually or in combination. The blocks or steps may be carried out in any order and/or in series or in parallel. Further, blocks or steps may be omitted or added to method 400.

The blocks of method 400 may be carried out by various elements of computing devices 104a-104g of FIG. 1, receiver device 215 of FIG. 2, and/or computing device 300 of FIG. 3, as illustrated and described in reference to the respective figures.

Block 410 involves receiving, by a first computing device, a plurality of metadata associated with a respective plurality of computing devices, wherein each metadata comprises an indication of a cryptographic fingerprint of secret data known to an associated computing device.

Block 420 involves receiving, by the first computing device and over a short-range wireless communication mode, a ciphertext message broadcast by a second computing device, the ciphertext message having been generated at the second computing device by an encryption algorithm that conforms the ciphertext message to a constrained packet size associated with the communication mode, wherein the encryption algorithm has a secure pseudo-random permutation (PRP) property, and wherein a cryptographic fingerprint is derivable from the ciphertext message.

Block 430 involves generating, from a decrypted version of the received ciphertext message, the cryptographic fingerprint. For example, metadata corresponding to each computing device includes a key and a fingerprint. The key and fingerprint may be used in tandem to generate the decrypted version. For example, the key and the fingerprint for device A may be used in tandem. However, a key from device A and a fingerprint from device B (or vice versa), may not be used. In some embodiments, every metadata from every device may be used for comparison purposes. However, there schemes may be configured that may enable trying a subset of all the metadata. Accordingly, for a particular set of metadata, that metadata's key may be used to decrypt, and the corresponding fingerprint may be checked.

Block 440 involves comparing the generated cryptographic fingerprint with cryptographic fingerprints associated with previously received plurality of metadata.

Block 450 involves, upon a determination that the generated cryptographic fingerprint matches a cryptographic fingerprint associated with one of the previously received plurality of metadata, establishing an integrity of the ciphertext message, wherein the establishing of the integrity is based on the PRP property of the encryption algorithm.

Some embodiments involve, upon the determination that the generated cryptographic fingerprint matches the cryptographic fingerprint associated with one of the previously received plurality of metadata, identifying a matching computing device corresponding to the matching cryptographic fingerprint. Such embodiments also involve identifying the second computing device as the matching computing device.

In some embodiments, the encryption algorithm is a variable-input-length (VIL) encryption algorithm for fractional-block message data. For example, the encryption algorithm may be a length doubling block cipher. A block cipher generally refers to a deterministic function that encrypts a bit string of length n into a bit string of the same length.

In some embodiments, the constrained packet size associated with the communication mode is 31 bytes.

In some embodiments, a size of the ciphertext message is less than 32 bytes. In such embodiments, the encryption algorithm is a length doubling algorithm with tweakable block ciphers.

In some embodiments, a size of the ciphertext message is greater than 32 bytes. In some embodiments, the encryption algorithm is a wide block cipher algorithm. A wide block cipher algorithm is applicable to ciphertext messages of size between 16 and 32 bytes. However, LDT is computationally less resource intensive than wide block ciphers making it a preferred choice over the wide block ciphers. Also, LDT cannot be applied to ciphertext messages of size greater than or equal to 2× the block size (=32 bytes for AES). Some examples of wide block cipher algorithms may be, for example, a Protected IV (PIV) construction, TCT, and so forth. A format preserving encryption scheme may be applied to ciphertext messages of size less than 1 block.

Some embodiments involve determining that the second computing device is within a threshold distance of the first computing device. Such embodiments may additionally involve performing, based on the determination that the second computing device is within the threshold distance, a proximate interaction with the second computing device. In some embodiments, the proximate interaction may be associated with an application installed on the first computing device. Such embodiments also involve performing, via an application programming interface (API), the proximate interaction associated with the application.

Some embodiments involve receiving, by the first computing device and over the short-range wireless communication mode, a second ciphertext message broadcast by a third computing device. Such embodiments involve generating, from a decrypted version of the received second ciphertext message, a second cryptographic fingerprint associated with the second ciphertext message. Such embodiments also involve comparing the second cryptographic fingerprint associated with the second ciphertext message to the cryptographic fingerprints associated with previously received plurality of metadata. Such embodiments additionally involve determining that the second cryptographic fingerprint associated with the second ciphertext message does not match the cryptographic fingerprints associated with previously received plurality of metadata. Such embodiments also involve determining, based on the pseudo-random permutation property of the encryption algorithm, that one or more of: (i) that an integrity of the second ciphertext message has been compromised or (ii) that the third computing device is an unidentified device.

In some embodiments the receiving of the ciphertext message comprises scanning, by the first computing device, for computing devices within a threshold distance of the first computing device.

In some embodiments, the short-range wireless communication mode is a near field communication (NFC) mode.

In some embodiments, the short-range wireless communication mode is a Bluetooth mode.

Some embodiments involve providing, via an application programming interface (API), the authenticating of the integrity of the received ciphertext message to an application installed on the first computing device.

Some embodiments involve providing, via an application programming interface (API), the identifying of the second computing device to an application installed on the first computing device.

In some embodiments, the cryptographic fingerprint includes a cryptographic checksum.

In some embodiments, the receiving of the plurality of metadata comprises periodically receiving the plurality of metadata from a remote server, wherein the plurality of metadata having been uploaded to the remote server by the plurality of computing devices.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods. Thus, the computer readable media may include secondary or persistent long-term storage, like read only memory (ROM), optical or magnetic disks, compact disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A computer-implemented method, comprising:
receiving, by a first computing device, a plurality of metadata associated with a respective plurality of computing devices, wherein each metadata comprises an indication of a cryptographic fingerprint of secret data known to an associated computing device;
receiving, by the first computing device and over a short-range wireless communication mode, a ciphertext message broadcast by a second computing device, the ciphertext message having been generated at the second computing device by an encryption algorithm that conforms the ciphertext message to a constrained packet size associated with the communication mode, wherein the encryption algorithm has a secure pseudo-random permutation (PRP) property, and wherein a cryptographic fingerprint is derivable from the ciphertext message;
generating, from a decrypted version of the received ciphertext message, the cryptographic fingerprint;
comparing the generated cryptographic fingerprint with cryptographic fingerprints associated with previously received plurality of metadata; and
upon a determination that the generated cryptographic fingerprint matches a cryptographic fingerprint associated with one of the previously received plurality of metadata, establishing an integrity of the ciphertext message, wherein the establishing of the integrity is based on the PRP property of the encryption algorithm.

2. The computer-implemented method of claim 1, further comprising:
upon the determination that the generated cryptographic fingerprint matches the cryptographic fingerprint associated with one of the previously received plurality of metadata, identifying a matching computing device corresponding to the matching cryptographic fingerprint; and
identifying the second computing device as the matching computing device.

3. The computer-implemented method of claim 1, wherein the encryption algorithm is a variable-input-length (VIL) encryption algorithm for fractional-block message data.

4. The computer-implemented method of claim 1, wherein the constrained packet size associated with the communication mode is 31 bytes.

5. The computer-implemented method of claim 1, wherein a size of the ciphertext message is less than 32 bytes.

6. The computer-implemented method of claim 5, wherein the encryption algorithm is a length doubling algorithm with tweakable block ciphers.

7. The computer-implemented method of claim 1, wherein a size of the ciphertext message is greater than 32 bytes.

8. The computer-implemented method of claim 7, wherein the encryption algorithm is a wide block cipher algorithm.

9. The computer-implemented method of claim 1, further comprising:
determining that the second computing device is within a threshold distance of the first computing device.

10. The computer-implemented method of claim 9, further comprising:
performing, based on the determining that the second computing device is within the threshold distance, a proximate interaction with the second computing device.

11. The computer-implemented method of claim 10, wherein the proximate interaction is associated with an application installed on the first computing device, and further comprising:
performing, via an application programming interface (API), the proximate interaction associated with the application.

12. The computer-implemented method of claim 1, further comprising:
receiving, by the first computing device and over the short-range wireless communication mode, a second ciphertext message broadcast by a third computing device;
generating, from a decrypted version of the received second ciphertext message, a second cryptographic fingerprint associated with the second ciphertext message;
comparing the second cryptographic fingerprint associated with the second ciphertext message to the cryptographic fingerprints associated with previously received plurality of metadata;
determining that the second cryptographic fingerprint associated with the second ciphertext message does not match the cryptographic fingerprints associated with previously received plurality of metadata; and
determining, based on the pseudo-random permutation property of the encryption algorithm, that one or more of: (i) that an integrity of the second ciphertext message has been compromised or (ii) that the third computing device is an unidentified device.

13. The computer-implemented method of claim 1, wherein the receiving of the ciphertext message comprises scanning, by the first computing device, for computing devices within a threshold distance of the first computing device.

14. The computer-implemented method of claim 1, wherein the short-range wireless communication mode is a near field communication (NFC) mode.

15. The computer-implemented method of claim 1, wherein the short-range wireless communication mode is a Bluetooth mode.

16. The computer-implemented method of claim 1, further comprising:
providing, via an application programming interface (API), the authenticating of the integrity of the received ciphertext message to an application installed on the first computing device.

17. The computer-implemented method of claim 1, further comprising:
providing, via an application programming interface (API), the identifying of the second computing device to an application installed on the first computing device.

18. The computer-implemented method of claim 1, wherein the cryptographic fingerprint comprises a cryptographic checksum.

19. The computer-implemented method of claim 1, wherein the receiving of the plurality of metadata comprises periodically receiving the plurality of metadata from a remote server, wherein the plurality of metadata having been uploaded to the remote server by the plurality of computing devices.

20. A computing device, comprising:
one or more processors; and
data storage, wherein the data storage has stored thereon computer-executable instructions that, when executed by the one or more processors, cause the computing device to carry out functions comprising:
receiving, by the computing device, a plurality of metadata associated with a respective plurality of computing devices, wherein each metadata comprises an indication of a cryptographic fingerprint of secret data known to an associated computing device;
receiving, by the computing device and over a short-range wireless communication mode, a ciphertext message broadcast by a second computing device, the ciphertext message having been generated at the second computing device by an encryption algorithm that conforms the ciphertext message to a constrained packet size associated with the communication mode, wherein the encryption algorithm has a secure pseudo-random permutation (PRP) property, and wherein a cryptographic fingerprint is derivable from the ciphertext message;
generating, from a decrypted version of the received ciphertext message, the cryptographic fingerprint;
comparing the generated cryptographic fingerprint with cryptographic fingerprints associated with previously received plurality of metadata; and
upon a determination that the generated cryptographic fingerprint matches a cryptographic fingerprint associated with one of the previously received plurality of metadata, establishing an integrity of the ciphertext message, wherein the establishing of the integrity is based on the PRP property of the encryption algorithm.

21. (canceled)

22. (canceled)

23. An article of manufacture comprising one or more non-transitory computer readable media having computer-readable instructions stored thereon that, when executed by one or more processors of a computing device, cause the computing device to carry out functions comprising:
receiving, by the computing device, a plurality of metadata associated with a respective plurality of computing devices, wherein each metadata comprises an indication of a cryptographic fingerprint of secret data known to an associated computing device;
receiving, by the computing device and over a short-range wireless communication mode, a ciphertext message broadcast by a second computing device, the ciphertext message having been generated at the second computing device by an encryption algorithm that conforms the ciphertext message to a constrained packet size associated with the communication mode, wherein the encryption algorithm has a secure pseudo-random permutation (PRP) property, and wherein a cryptographic fingerprint is derivable from the ciphertext message;
generating, from a decrypted version of the received ciphertext message, the cryptographic fingerprint;
comparing the generated cryptographic fingerprint with cryptographic fingerprints associated with previously received plurality of metadata; and
upon a determination that the generated cryptographic fingerprint matches a cryptographic fingerprint associated with one of the previously received plurality of metadata, establishing an integrity of the ciphertext message, wherein the establishing of the integrity is based on the PRP property of the encryption algorithm.

24. (canceled)
